(19) United States
(12) Patent Application Publication
(10) Pub. No.: US 2023/0244995 A1
(43) Pub. Date: Aug. 3, 2023

(54) APPARATUS AND METHOD FOR EVALUATING MACHINE LEARNING MODEL

(71) Applicant: ELECTRONICS AND TELECOMMUNICATIONS RESEARCH INSTITUTE, Daejeon (KR)

(72) Inventors: Soohwan LEE, Daejeon (KR); Jihoon SUNG, Daejeon (KR); Myung Ki SHIN, Daejeon (KR)

(21) Appl. No.: 18/095,689

(22) Filed: Jan. 11, 2023

(30) Foreign Application Priority Data
Jan. 11, 2022 (KR) 10-2022-0003896
Mar. 29, 2022 (KR) 10-2022-0039029
Apr. 12, 2022 (KR) 10-2022-0045373
May 4, 2022 (KR) 10-2022-0055438
May 20, 2022 (KR) 10-2022-0061844
Nov. 4, 2022 (KR) 10-2022-0146311
Jan. 9, 2023 (KR) 10-2023-0003108
Jan. 10, 2023 (KR) 10-2023-0003609
Jan. 11, 2023 (KR) 10-2023-0004173

(51) Int. Cl. G06N 20/00

(52) U.S. Cl. CPC G06N 20/00

(57) ABSTRACT

A method and an apparatus for monitoring the accuracy of provisioned ML model through steps of: determining to check the accuracy of the ML model provisioned to the NWDAF containing AnLF, collecting data for monitoring the accuracy of the ML model, and reselecting or retraining an ML model of which accuracy is determined to be low based on the collected data are provided.

### CROSS-REFERENCE TO RELATED APPLICATIONS

This application claims priority to and the benefit of Korean Patent Application No. 10-2022-0003896 filed in the Korean Intellectual Property Office on Jan. 11, 2022, Korean Patent Application No. 10-2022-0039029 filed in the Korean Intellectual Property Office on Mar. 29, 2022, Korean Patent Application No. 10-2022-0045373 filed in the Korean Intellectual Property Office on Apr. 12, 2022, Korean Patent Application No. 10-2022-0055438 filed in the Korean Intellectual Property Office on May 4, 2022, Korean Patent Application No. 10-2022-0061844 filed in the Korean Intellectual Property Office on May 20, 2022, Korean Patent Application No. 10-2022-0146311 filed in the Korean Intellectual Property Office on Nov. 4, 2022, Korean Patent Application No. 10-2023-0003108 filed in the Korean Intellectual Property Office on Jan. 9, 2023, Korean Patent Application No. 10-2023-0003609 filed in the Korean Intellectual Property Office on Jan. 10, 2023, and Korean Patent Application No. 10-2023-0004173 filed in the Korean Intellectual Property Office on Jan. 11, 2023, the entire contents of which are incorporated herein by reference.

### BACKGROUND

### 1. Field of the Invention

This disclosure relates to a method and apparatus for evaluating machine learning models.

### 2. Description of Related Art

In the 5G mobile communication system, a network data analytics function (NWDAF) is introduced for automation and optimization of the system. The NWDAF collects data distributed to each function within the cellular network, performs statistical processing and prediction based on the collected data, generates analysis information (Analytics) for the state of the entire system, and then transmits the generated analytics to each network element (e.g., 5G NF, OAM, etc.) that controls the system.

The analytics of the NWDAF is generated by an analytics logical function (AnLF), which is a logic function of NWDAF, and the AnLF may utilize a machine learning model trained by machine learning model training logic function (MTLF) to generate the analytics.

In order to provide accurate machine learning-based analytics, the randomly changing state of the network needs to have a constant stationary distribution, and the changes in the stationary state are related to changes in the applied network policies, changes in configuration of internal network equipment, and various events outside the network (e.g., disasters, accidents, events, etc.).

### SUMMARY

An embodiment provides a method for evaluating an ML model.

Another embodiment provides a method for using an ML model.

Yet another embodiment provides an NWDAF evaluating an ML model.

According to an embodiment, a method for evaluating a machine learning (ML) model is provided. The method includes: receiving a provisioning request for the ML model from a network data analytics function (NWDAF) including an analytics logical function (AnLF) in a cellular system; collecting data for monitoring accuracy of the ML model; and evaluating the ML model based on the collected data.

In an embodiment, the method may further include: reselecting or retraining an ML model of which the accuracy is determined to be deteriorated according to the evaluation result of the ML model; and providing the reselected or retrained ML model to the NWDAF.

In an embodiment, the receiving a provisioning request for the ML model from the NWDAF may include receiving, from the NWDAF, at least one of subscription correlation ID, ML model filter information, a target of ML model reporting, ML model reporting information, indicators of multiple ML model, ML model accuracy level, a feedback indicator, a target of feedback, feedback information, and expiration time.

In an embodiment, the method may include determining to check the accuracy of the ML model based on a notification received from a policy control function (PCF) in the cellular system.

In an embodiment, the notification may include a notification about a change in policy for user equipment (UE).

In an embodiment, the collecting data for monitoring accuracy of the ML model may include: subscribing to the NWDAF by invoking a service operation for accuracy provisioning; and receiving accuracy information of the ML model from the NWDAF from the NWDAF.

In an embodiment, receiving accuracy information of the ML model from the NWDAF from the NWDAF may further include receiving a storage transaction identifier from the NWDAF.

In an embodiment, the collecting data for monitoring accuracy of the ML model may further include retrieving data from analytics data repository (ADRF) using the storage transaction identifier.

According to another embodiment, a method for using a machine learning (ML) model is provided. The method include: requesting provisioning of the ML model to a network data analytics function (NWDAF) including an ML model training logical function (MTLF) in a cellular system; transmitting accuracy information of the ML model to the NWDAF when a service operation for accuracy provisioning is invoked by the NWDAF; and receiving a reselected or retrained ML model from the NWDAF after the ML model is evaluated based on the accuracy information by the NWDAF.

In an embodiment, the requesting provisioning of the ML model to the NWDAF may include transmitting, to the NWDAF, at least one of subscription correlation ID, ML model filter information, a target of ML model reporting, ML model reporting information, indicators of multiple ML model, ML model accuracy level, a feedback indicator, a target of feedback, feedback information, and expiration time.

In an embodiment, the transmitting the accuracy information of the ML model to the NWDAF may include sending a storage transaction identifier to the NWDAF.

According to yet another embodiment, a network data analytics function (NWDAF) including a machine learning (ML) model training logical function (MTLF) in a cellular system is provided. The NWDAF include: a processor, a memory, and a communication device, wherein the processor executes a program stored in the memory to perform: receiving a provisioning request for an ML model from a first NWDAF including an analytics logical function (AnLF) in the cellular system; collecting data for monitoring accuracy of the ML model; and evaluating the ML model based on the collected data.

In an embodiment, the processor may execute the program to further perform: reselecting or retraining an ML model of which the accuracy is determined to be deteriorated according to the evaluation result of the ML model; and providing the reselected or retrained ML model to the NWDAF.

In an embodiment, when performing the receiving the provisioning request for the ML model from the NWDAF, the processor may perform receiving, from the NWDAF, at least one of subscription correlation ID, ML model filter information, a target of ML model reporting, ML model reporting information, indicators of multiple ML model, ML model accuracy level, a feedback indicator, a target of feedback, feedback information, and expiration time.

In an embodiment, the processor may execute the program to further perform determining to check the accuracy of the ML model based on a notification received from a policy control function (PCF) in the cellular system.

In an embodiment, the notification may include a notification about a change in policy for user equipment (UE).

In an embodiment, when performing the collecting data for monitoring accuracy of the ML model, the processor may perform: subscribing to the NWDAF by invoking a service operation for accuracy provisioning; and receiving accuracy information of the ML model from the NWDAF from the NWDAF.

In an embodiment, when performing the receiving the accuracy information of the ML model from the NWDAF from the NWDAF, the processor may perform receiving a storage transaction identifier from the NWDAF.

In an embodiment, when performing the collecting data for monitoring accuracy of the ML model, the processor may perform retrieving data from analytics data repository (ADRF) using the storage transaction identifier.

### BRIEF DESCRIPTION OF THE DRAWINGS

FIG. 1 is a diagram illustrating a system for generating analytics according to an embodiment.

FIG. 2 is a block diagram illustrating an NWDAF adjusting randomness of the analytics according to an embodiment.

FIG. 3 is a flowchart illustrating a method for selecting an ML model for analytics according to an embodiment.

FIG. 4 is a flowchart illustrating a method for provisioning an ML model for improving accuracy of analytics of NWDAF according to an embodiment.

FIG. 5 is a flowchart illustrating an AnLF-based error monitoring method according to an embodiment.

FIG. 6 is a flowchart illustrating an AnLF-based error monitoring method according to another embodiment.

FIG. 7 is a flowchart illustrating an MTLF-based error monitoring method according to an embodiment.

FIG. 8 is a flowchart illustrating an MTLF-based error monitoring method according to another embodiment.

FIG. 9 is a flowchart illustrating a method for detecting dynamics on analytics by MTLF according to an embodiment.

FIG. 10 is a flowchart illustrating a method for detecting dynamics on analytics by MTLF according to another embodiment.

FIG. 11 is a flowchart illustrating a subscription/unsubscription method of the ML model for analytics according to an embodiment.

FIG. 12 is a flowchart illustrating the subscription/unsubscription method of the ML model for analytics according to another embodiment.

FIG. 13 is a flowchart illustrating a method for monitoring accuracy of an ML model according to an embodiment.

FIG. 14 is a flowchart illustrating a method for monitoring the accuracy of the ML model according to another embodiment.

FIG. 15 is a block diagram illustrating a network function according to an embodiment.

### DETAILED DESCRIPTION OF THE EMBODIMENTS

In the following detailed description, only certain embodiments of the present invention have been shown and described in detail with reference to the accompanying drawing, simply by way of illustration. However, the present disclosure may be implemented in various different forms and is not limited to the embodiments described herein. Further, in order to clearly describe the description in the drawing, parts not related to the description are omitted, and similar reference numerals are attached to similar parts throughout the specification.

Throughout the specification, a terminal may be called user equipment (UE), mobile station (MS), a mobile terminal (MT), an advanced mobile station (AMS), a high reliability mobile station (HR-MS), a subscriber station (SS), a portable subscriber station (PSS), an access terminal (AT), a machine type communication device (MTC device), and the like and may also include all or some of the functions of the MS, the MT, the AMS, the HR-MS, the SS, the PSS, the AT, the UE, the MTCH device, and the like.

Further, the base station (BS) may be called an advanced base station (ABS), a high reliability base station (HR-BS), a node B, an evolved node B (eNodeB), an access point (AP), a radio access station (RAS), a base transceiver station (BTS), a mobile multi-hop relay (MMR)-BS, a relay station (RS) serving as a base station, a relay node (RN) serving as a base station, an advanced relay station (RS) serving as a base station, a high reliability relay station (HR-RS) serving as a base station, small base stations (a femto base station (femto BS), a home node B (HNB), a home eNodeB (HeNB), a pico base station (pico BS), a macro base station (macro BS), a micro base station (micro BS), and the like), and the like and may also include all or some of the functions of the ABS, the node B, the eNodeB, the AP, the RAS, the BTS, the MMR-BS, the RS, the RN, the ARS, the HR-RS, the small base stations, and the like.

In this specification, unless explicitly described to the contrary, the word “comprises”, and variations such as “including” or “containing”, will be understood to imply the inclusion of stated elements but not the exclusion of any other elements.

As used herein, “A or B”, “at least one of A and B”, “at least one of A or B”, “A, B, or C”, “at least one of A, B, and C”, and “at least one of A, B, or C” each may include any one of, or all possible combinations of, items listed together in the corresponding one of the phrases.

In this specification, expressions described in singular can be interpreted as singular or plural unless explicit expressions such as “one” or “single” are used.

In this specification, “and/or” includes all combinations of each and at least one of the mentioned elements.

In this specification, terms including ordinal numbers such as first and second may be used to describe various configurations elements, but the elements are not limited by the terms. The terms may be only used to distinguish one element from another element. For example, a first element may be named a second element without departing from the right range of the present disclosure, and similarly, a second element may be named a first element.

In the flowchart described with reference to the drawings in this specification, the order of the operations may be changed, several operations may be merged, certain operations may be divided, and specific operations may not be performed.

The system described in this disclosure not only greatly increases the accuracy of analytics generated by a network data analytics function (NWDAF), but also improves efficiency of the 5G system by monitoring policy changes and adjusting analytics to the policy changes. To this end, the NWDAF for capturing the policy changes in the cellular system and an NWDAF framework for adapting to the changed policy are described below.

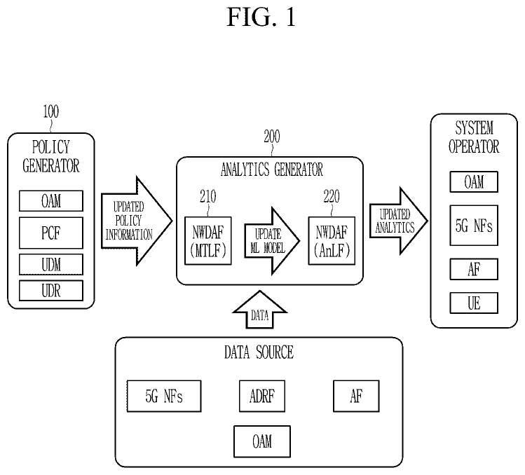

FIG. 1 is a diagram illustrating a system for generating analytics according to an embodiment.

Referring to FIG. 1, a system for generating analytics according to an embodiment may include a policy generator 100 and an analytics generator 200. The system for generating analytics may collect data for deriving the analytics from data sources inside and outside the cellular network and provide the derived analytics to the system operator.

In an embodiment, the policy generator 100 may determine a policy for a cellular system (e.g., 5G system). Referring to FIG. 1, the policy generator 100 may include OAM (Operations, Administration, and Maintenance), a policy control function (PCF), a unified data management (UDM), and unified data repository (UDR). The OAM may configure the PCF to generate and implement policies appropriate to the system operator side. The PCF may determine a UE policy, an access and mobility management (AM) policy, and a session management (SM) policy and transmit the determined policy to the system operator (e.g., UE, access and mobility management function (AMF), session management function (SMF)). The UDM and UDR may manage subscriber data.

In an embodiment, the analytics generator 200 may generate requested analytics and provide the generated analytics to the system operator. Referring to FIG. 1, the analytics generator 200 may include at least one NWDAF and the NWDAF may include MTLF 210 and/or AnLF 220. For example, each NWDAF included in the analytics generator 200 may include both the MTLF 210 and AnLF 220. Alternatively, one NWDAF included in the analytics generator 200 may include the MTLF 210 and another NWDAF included in the analytics generator 200 may include the AnLF 220. That is, the MTLF 210 and AnLF 220 may be positioned in different NWDAFs.

The MTLF 210 may generate and train an ML model for the AnLF 220 and provide the trained ML model to the AnLF 220. The AnLF 220 may generate analytics (e.g., statistics of network data or predicted values of network data) based on data from the data sources using the ML model provided by the MTLF 210.

In an embodiment, the system operator may request the analytics from the analytics generator 200 and, based on the analytics received from the analytics generator 200, determine appropriate action (e.g., UE mobility management, session management, policy control, etc.) to achieve optimal operation of the entire system. Referring to FIG. 1, the system operators may include the OAM, 5G NFs, AFs, and/or UE. Alternatively, the system operator may include all entities that may affect the cellular system.

The data source may provide network data to the analytics generator 200 according to the request of the analytics generator 200. The data sources may include 5G NFs, analytics data repository (ADRF), AFs, and the OAM. In an embodiment, the analytics generator 200 may request real-time data as well as historical data for the data source to generate the analytics and train the ML model.

In an embodiment, the system operator may operate the system by operating internal entities (e.g., OAM, 5G NFs, etc.) of the system operator based on the analytics provided by the analytics generator 200. Therefore, the analytics generator 200 needs to provide the analytics with high accuracy to the system operator. To increase the accuracy of the analytics, in an embodiment, the analytics generator 200 may estimate randomness for each information element of the analytics (i.e., all information within all analytics provided by the NWDAF) and provide the analytics to the system operator based on the estimated randomness. In addition, since the randomness for the analytics may change according to various events in the system such as the policy change, configuration change, and unexpected events (e.g., disasters, concerts, etc.), the analytics generator 200 may track dynamics that may affect the randomness of the analytics.

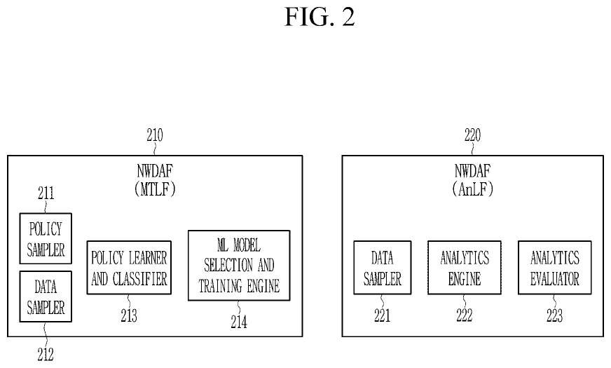

FIG. 2 is a block diagram illustrating an NWDAF adjusting randomness of the analytics according to an embodiment.

Referring to FIG. 2, the MTLF 210 (or NWDAF including MTLF) may include a policy sampler 211, data sampler 212, policy learner and classifier 213, and ML model selection and training engine 214.

The policy sampler 211 may communicate with the policy generator 100 and sample an applied policy to generate the analytics.

The data sampler 212 may collect data from the data sources. In an embodiment, the data sampler may collect the data from the data sources for training an ML model in the MTLF, generating the desired analytics in the AnLF, evaluating the performance of the analytics generator 200, and monitoring changes on randomness for the analytics. In an embodiment, the performance of the analytics generator 200 may be the accuracy of the trained ML model and/or the accuracy of the analytics.

The policy sampler 211 of the MTLF 210 may subscribe to a service of the policy generator which notifies the MTLF 210 of updated policy information. In an embodiment, the updated policy information may include an indication of the policy to be updated. In addition, the policy sampler 211 may transfer the sampled policy to the policy learner and classifier 213 in the MTLF 210 with the policy information retrieved from the policy generator 100.

The policy learner and classifier 213 of the MTLF 210 may classify the applied policy into several classes for the purpose of capturing the changes on randomness for analytics. In order to build and update the classes and classification criteria of the policy, the policy learner and classifier 213 may apply machine learning techniques (e.g., clustering by unsupervised learning) to the updated policy information and the data collected by the data sampler after the policy update is completed. The policy learner and classifier 213 may flexibly update the number of classes and the criteria for classes.

When the updated policy information is transmitted from the policy sampler 211, the policy learner and classifier 213 may map the updated policy to a specific class based on the updated policy information and/or sampled data. Then, the policy learner and classifier 213 may transfer information about the class to which the updated policy is mapped to the ML model selection and training engine 214. In an embodiment, when the policy learner and classifier 213 determines to map the updated policy into different classes than before, the randomness for the analytics may be changed.

The ML model selection and training engine 214 may determine and train an ML model for specific analytics based on the mapped class information from the policy learner and classifier 213. When the mapped class information is changed for the analytics, the ML model selection and training engine 214 may re-select or re-train the ML model for the analytics, or may establish a new ML model for the analytics. Referring to FIG. 2. when the ML model is changed or re-trained, the ML model selection and training engine 214 may transfer the updated ML model to the AnLF 220 generating the analytics for the targets to which the updated policy is applied.

Referring to FIG. 2, the AnLF 220 (or the NWDAF including AnLF 220) may include a data sampler 221, an analytics engine 222, and an analytics evaluator 223. In an embodiment, the AnLF 220 may generate analytics requested by the system operator.

The data sampler 222 may collect data to generate the analytics and evaluate accuracy of the analytics.

The analytics engine 222 may generate requested analytics while applying an ML model to the data collected by the data sampler. The analytics engine 222 may transfer the generated analytics to the system operator.

The analytics evaluator 223 may measure and estimate the accuracy of the analytics generated by the analytics engine 222 with the data collected by the data sampler 221 in the AnLF 220 after the analytics is generated, compared to each estimated information element in the analytics.

The analytics evaluator 223 may transfer a result of the measurement regarding the accuracy of the analytics to the MTLF 210. When the measurement result is transferred to the MTLF 210, the MTLF 210 may utilize the measurement result to evaluate the provided ML model. When the accuracy of the generated analytics does not meet a predetermined threshold, the AnLF 220 may request the MTLF 210 to re-select/update the ML model.

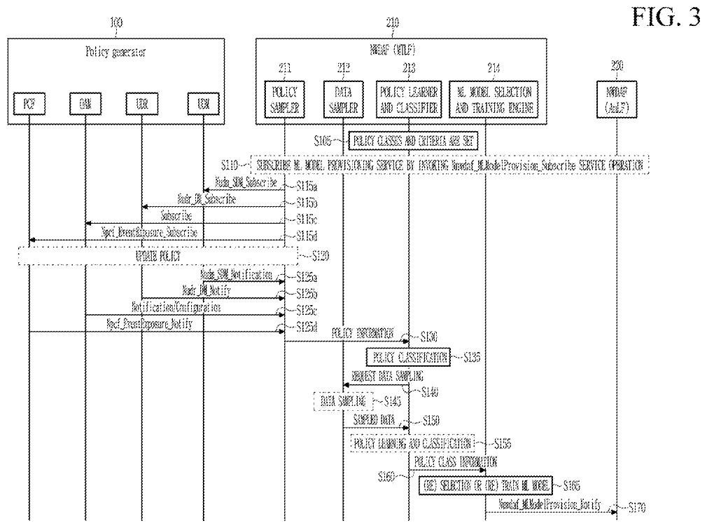

FIG. 3 is a flowchart illustrating a method for selecting an ML model for analytics according to an embodiment.

Referring to FIG. 3, the policy classes and criteria for the classes may be set by machine learning done by the policy learner and classifier 213 in the MTLF 210 or by the configuration of the operator (S105). In addition, when the NWDAF including AnLF 220 subscribes to the ML model provisioning service by invoking a service operation (e.g., Nnwdaf_MLModelProvision_Subscribe) that may be provided by the NWDAF including MTLF 210, the NWDAF including MTLF 210 may supply an ML model(s) to the NWDAF including AnLF 220 (S110).

Subsequently, the policy sampler 211 in the NWDAF including MTLF 210 may subscribe to at least one service that provides notification of changes to policies (e.g., UE policies, access and mobility related policies, session management related policies, etc.) applied to a predetermined target for the policy generator 100. (S115a, S115b, S115c, S115d). In an embodiment, the predetermined targets to which the policy is applied may include at least one of, for example, single-network slice selection assistance information (S-NSSAI)(s), UE identification (ID) (e.g., subscription permanent identifier (SUPI)), UE group ID(s), application ID(s), PDU session ID(s), serving AMF ID(s), SMF ID, and the combination of thereof.

When the policy generator 100 updates the policy for the predetermined target (S120), the function object (e.g., PCF, OAM, UDR, UDM) that updates the policy in the policy generator 100 may notify the changes on the policy to the NWDAF including MTLF 210 with the information of the updated policy (S125a, S125b, S125c, S125d).

In an embodiment, the information of the updated policy may include at least one of the indication(s) for the occurrence of the policy change, the target of the updated policy (e.g., S-NSSAI(s), UE ID (e.g., SUPI), UE group ID(s), application ID(s), PDU session ID(s), serving AMF ID(s), serving SMF ID(s)), updated policy ID, detailed information of the updated policy (e.g., policy and charging control (PCC) rules), AM policy, SM policy, and UE policy.

In an embodiment, even if the NWDAF including MTLF 210 does not subscribe to the OAM service, the OAM may directly provide updated policy information to the NWDAF including MTLF 210.

When the NWDAF including MTLF 210 receives the information of the updated policy, the policy sampler 211 may transfer the information of the updated policy to the policy learner and classifier 213 of the NWDAF including MTLF 210 (S130).

The NWDAF including MTLF 210 may classify policies by determining the class for each policy updated by policy generator 100 (S135).

The policy learner and classifier 213 of the NWDAF including MTLF 210 may determine the class of the policy using information of the updated policy. For example, the policy learner and classifier 213 of NWDAF including MTLF 210 may, when the updated policy ID and the detailed information of the updated policy (e.g., PCC rule, AM policy, SM policy, UE policy) is given, directly map the policy to a specific class using criteria for the information in the updated policy.

When the NWDAF containing MTLF 210 can not directly map the updated policy to a predetermined class with the given information of the updated policy (e.g., the information for the mapping is not sufficient) or the NWDAF including MTLF 210 determines to make a new class for the updated policy or to update the criteria for the classification of the class, the policy learner and classifier 213 of the NWDAF including MTLF 210 may further collect network data related to the updated policy and dynamics on the system incurred by the policy update from the data sampler 212 (S140). If the additional collection of the network data is not required, S140 to S150 may be skipped.

The data sampler 212 may collect the network data requested by the policy learner and classifier 213 from the data sources, for example, by triggering an Nnf_EventExposure_Subscribe service operation (S145). The data sampler 212 may send the collected network data to the policy learner and classifier 213 (S150).

The policy learner and classifier 213 of the NWDAF including MTLF 210 may determine the class for the updated policy and/or learn the characteristics of the updated policy through machine learning based on the collected data with the information of the updated policy (S155). For example, the MTLF 210 may cluster the policies via (un)supervised learning. When the NWDAF including MTLF 210 learns the characteristics of the updated policy, the number of classes and the criteria for distinguishing the classes may be updated.

The policy learner and classifier 213 may send the mapped class information of the updated policy to the ML model selection and training engine 214 in the NWDAF including MTLF 210 (S160).

When the updated policy is mapped to a new class or to a different class than the previous policy, the ML model selection and training engine 214 may (re)select a subscribed ML model for Nnwdaf_MLModelProvision service operation, or may generate a new ML model for the policy class, or may trigger (re)training of the ML model for the policy class (S165).

When the ML model is updated above, the NWDAF including MTLF 210 may send the updated ML model to the NWDAF including AnLF 220 by invoking Nnwdaf_MLModelProvision_Notify service operation (S170).

In an embodiment, when the NWDAF including AnLF 220 evaluates the provided ML model to be an inaccurate ML model, the NWDAF including AnLF 220 may send the evaluation results to the NWDAF including MTLF 210, and then the NWDAF including MTLF 210 may take the evaluation result of the ML model of the NWDAF including AnLF (220) into account to policy classification and selection of the ML model.

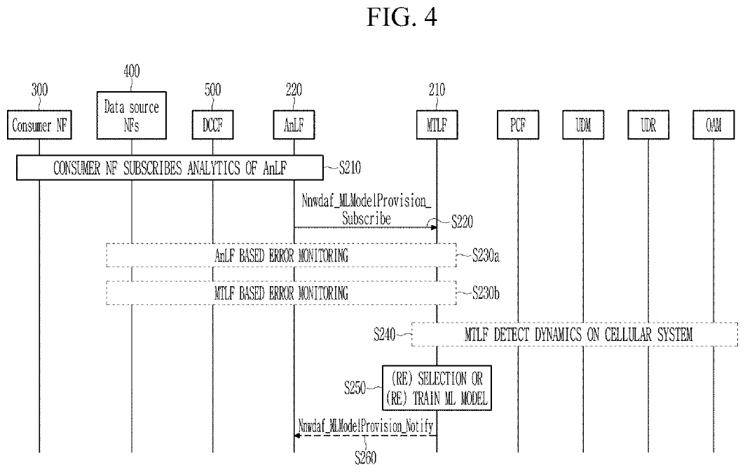

FIG. 4 is a flowchart illustrating a method for provisioning an ML model for improving accuracy of analytics of NWDAF according to an embodiment.

The method for provisioning an ML model according to an embodiment may improve accuracy of analytics generated by the NWDAF by activating the self-correction function of the NWDAF based on closed-loop control. In an embodiment, based on the closed-loop control between the AnLF and the MTLF, the NWDAF may activate a self-correction function to improve the accuracy of the analytics generated by the NWDAF. Specifically, a procedure for modifying the ML model to improve the accuracy of the analytics and a procedure for measuring the accuracy of the provided analytics are proposed.

In the analytics for prediction, the analytics provided by the NWDAF (i.e., desired data and events for the prediction) may be different to actual data or events that occurred during analytics target period, and such differences may become significant faults on the consumer NF action. In order to address potential faults on the NF action, in the method for provisioning the ML model according to an embodiment, the NWDAF may monitor the accuracy or error of the provided analytics and correct potential errors on the analytics.

In an embodiment, the NWDAF may include the AnLF for generating the analytics and the MTLF for providing the ML model for generating the analytics.

Since the AnLF generates the analytics inferred by the ML model provisioned by the MTLF, the errors on the analytics may be incurred by inappropriate ML model provision.

Therefore, the MTLF may monitor the errors on the analytics for checking the accuracy of the provisioned ML model. To this end, the method for provisioning the ML model according to an embodiment describes two options of AnLF-based error monitoring and MTLF-based error monitoring.

The MTLF may provide the ML models that rely on the belief that the 5GS will be in a similar state during analytics target period as the period when the trained data had been sampled. However, in fact, the configuration updates, policy changes, and various unexpected events on the 5GS may continuously occur during the analytics target period, and thus may incur the dynamics that the provisioned ML model have not been trained. Consequently, the accuracy of the NWDAF analytics may be significantly degraded. To address this, below, a method for detecting dynamics and provisioning a better ML model for the system is provided.

Referring to FIG. 4, the consumer NF 300 may subscribe to a service of the AnLF 220 through the DCCF 500 for analytics (or set of analytics) (S210).

The NWDAF including AnLF 220 may subscribe to a trained ML model(s) (or set of ML models) related to analytics ID(s) (or set of analytics IDs) by invoking Nnwdaf_MLModelProvision_Subscribe service operation (S220).

The NWDAF including AnLF 220 may monitor errors between the analytics generated by the ML model and the actual event, and send the monitoring result to the NWDAF including MTLF 210 (S230a).

Alternatively, the NWDAF including MTLF 210 may monitor the difference between the ML model training data and actual data (S230b).

The NWDAF including MTLF 210 may detect dynamics on a cellular system (e.g., 5GS) associated with the analytics (S240).

The NWDAF including MTLF 210 may reselect the trained ML model(s) (or set of trained ML models) associated with analytics (or set of analytics) or determine re-training of ML model trained based on the retrieved result in S230 to S240 (S250).

In an embodiment, each monitoring result and/or detection result of each step (S230a, S230b, and S240) may trigger a decision of the reselection and retraining of the ML model.

When the NWDAF including MTLF 210 selects a new trained ML model or retrains the ML model, the NWDAF including MTLF 210 may send the ML model to the NWDAF including AnLF 220 by invoking the Nnwdaf_MLModelProvision_Notify service operation (S260).

To support the method described in FIG. 4, some parameters may be added to the Nnwdaf_MLModel_Provision_Subscribe/Notify service operation.

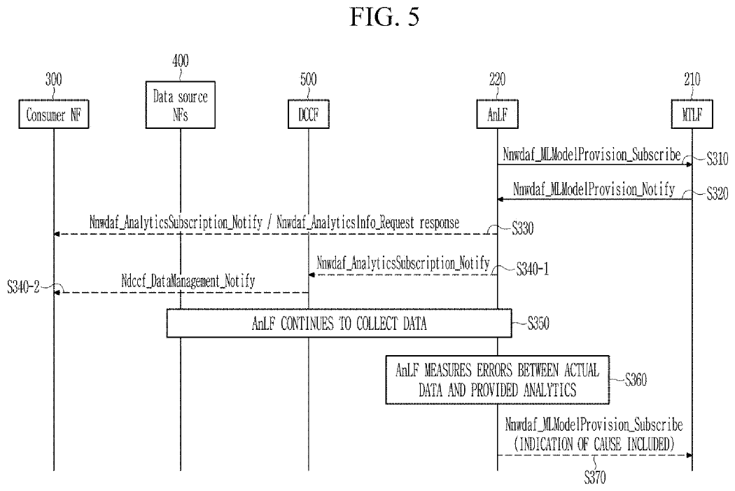

FIG. 5 is a flowchart illustrating an AnLF-based error monitoring method according to an embodiment.

In an embodiment, the NWDAF containing AnLF 220 may monitor errors on analytics provided from the ML model.

Referring to FIG. 5, the NWDAF containing AnLF 220 may subscribe to the trained ML model(s) (or set of trained ML models) associated with the analytics ID(s) (or set of analytics IDs) by invoking Nnwdaf_MLModelProvision_Subscribe service operation (S310).

The NWDAF containing MTLF 210 may provide the NWDAF containing AnLF 220 with trained ML model(s) (or set of trained ML models) associated with the analytics ID(s) (or set of analytics IDs). In addition, the NWDAF containing MTLF 210 may instruct the NWDAF containing AnLF 220 a threshold(s) (or set of thresholds) for the accuracy of the trained ML model by invoking the Nnwdaf_MLModelProvision_Notify service operation (S320).

The NWDAF containing AnLF 220 may generate analytics (or a set of analytics) and provide the analytics to the consumer NF according to the service operation of step S210 in FIG. 4 (S330, S340-1, S340-2). In addition, the NWDAF containing AnLF 220 may store the provided analytics to measure the accuracy or error through comparison with actual data.

The NWDAF containing AnLF 220 may continue to collect actual events and data related to the provided analytics during the analytics target period by triggering the data collection procedure (S350).

The NWDAF containing AnLF 220 may measure the accuracy of the analytics provided to the consumer NF by compared to the collected events/data (S360).

When the accuracy measured above is lower than the target accuracy of the analytics generated by NWDAF containing AnLF 220 and/or lower than the threshold for accuracy of the provided ML model, the NWDAF containing AnLF 220 send the errors with the indication of cause=“inaccuracy” to the NWDAF containing MTLF 210 (S370). The NWDAF containing AnLF 220 may transmit the error by invoking Nnwdaf_MLModelProvision_Subscribe service operation.

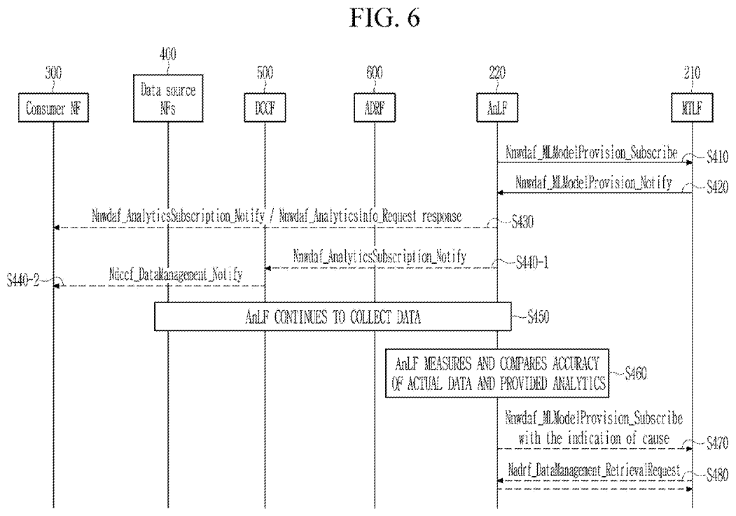

FIG. 6 is a flowchart illustrating an AnLF-based error monitoring method according to another embodiment.

Referring to FIG. 6, the NWDAF containing AnLF 220 may subscribe to a trained ML model(s) (or set of trained ML models) associated with an analytics ID(s) (or set of analytics IDs) by invoking the Nnwdaf_MLModelProvision_Subscribe service operation (S410).

The NWDAF containing MTLF 210 may provide the NWDAF containing AnLF 220 with trained ML model(s) (or set of trained ML models) associated with the analytics ID(s) (or set of analytics IDs). In addition, the NWDAF containing MTLF 210 may instruct the NWDAF including AnLF 220 a threshold(s) (or set of thresholds) for the accuracy of the trained ML model by invoking Nnwdaf_MLModelProvision_Notify service operation (S420).

The NWDAF containing AnLF 220 may generate analytics (or a set of analytics) and provide the analytics to the consumer NF according to the service operation of step S210 in FIG. 4 (S430, S440-1, S440-2). In addition, the NWDAF containing AnLF 220 may store the provided analytics to measure errors through comparison with actual data. The NWDAF including AnLF 220 may request that ADRF 600 stores the events and data used for generating the analytics by triggering Nadrf_DataManagement_StorageRequest.

The NWDAF containing AnLF 220 may continue to collect actual events and data related to the provided analytics during the analytics target period by triggering the data collection procedure (S450). In another embodiment, the NWDAF containing AnLF 220 may use the ADRF 600 to collect real events. In an embodiment, the NWDAF containing AnLF 220 may request that the ADRF 600 stores the actual events and data related to the provided analytics during the analytics target period by triggering Nadrf_DataManagement_StorageRequest.

The NWDAF containing AnLF 220 may measure the error between the analytics provided to the consumer NF and the collected event/data (S460).

When the error measured above is higher than the target accuracy of the analytics generated by the NWDAF containing AnLF 220 and/or lower than the threshold for accuracy of the provided ML model, the NWDAF accuracy AnLF 220 may send the errors with the indication of cause=“inaccuracy” to the NWDAF containing MTLF 210 (S470). The NWDAF containing AnLF 220 may transmit the errors by invoking Nnwdaf_MLModelProvision_Subscribe service operation.

When the NWDWAF containing AnLF 220 requests to store the actual events and data related to provided analytics at the ADRF 600, the AnLF 220 may include ADRF information (e.g., ADRF ID, Storage Transaction Identifier, Notification Correlation ID) in Nnwdaf_MLModelProvision_Subscribe service operation.

In an embodiment, the ADRF information may include a pair of an ADRF ID and a storage transaction identifier, or a notification correlation ID, or both.

The NWDAF containing MTLF 210 may retrieve the actual events from the ADRF 600 by invoking Nadrf_DataManagementRetrievalRequest service operation. That is, the MTLF 210 may retrieve the actual events and data related to the provided analytics and events and data used to generate the analytics from the ADRF 600 during the analytics target period by invoking the Nadrf_DataManagementRetrievalRequest service operation.

When the actual event is retrieved, the NWDAF containing MTLF 210 may re-evaluate the provisioned ML model by comparing the retrieved event to the trained data (S480).

In an embodiment, step S480 may be triggered by internal logic of the NWDAF containing MTLF 210 or when the NWDAF containing MTLF 210 receives notification from the ADRF 600. The notification from the ADRF 600 may be transferred to the NWDAF containing MTLF 210 through a Nadrf_DataManagement_RetrievalNotify service operation including a fetch instruction and the notification correlation ID.

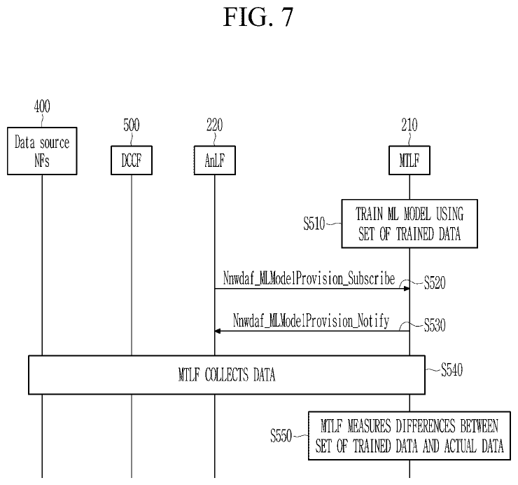

FIG. 7 is a flowchart illustrating an MTLF-based error monitoring method according to an embodiment.

Referring to FIG. 7, the NWDAF containing MTLF 210 may train an ML model with a set of trained data (S510). In this case, the MTLF 210 may store the set of trained data or characteristics of the trained data (e.g., mean, variance, etc.).

The NWDAF containing AnLF 220 may subscribe to a trained ML model(s) (or set of trained ML models) associated with the analytics ID(s) (or set of analytics IDs) by invoking the Nnwdaf_MLModelProvision_Subscribe service operation (S520).

The NWDAF containing MTLF 210 may provide the trained ML model(s) (or the set of trained ML models) associated with the analytics ID(s) (or set of analytics IDs) to the NWDAF containing AnLF 220 by invoking an Nnwdaf_MLModelProvision_Notify service operation (S530).

The NWDAF containing MTLF 210 may collect actual events and data related to the analytics for the ML model during the ML model target period by triggering the data collection procedure (S540). The NWDAF containing MTLF 210 may discover date source NFs by exploiting a target of ML model reporting and ML Model Filter Information to collect the actual events and data.

The NWDAF containing MTLF 210 may measure the differences between the set of trained data at step S510 and collected events/data at step S540 (S550).

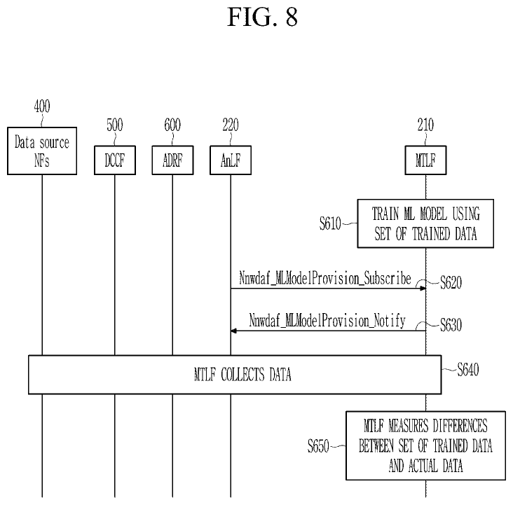

FIG. 8 is a flowchart illustrating an MTLF-based error monitoring method according to another embodiment.

Referring to FIG. 8, the NWDAF containing MTLF 210 may train an ML model with a set of trained data (S610). In this case, the MTLF 210 may store the set of trained data or characteristics of the trained data (e.g., mean, variance, etc.).

The NWDAF containing AnLF 220 may subscribe to the trained ML model(s) (or set of trained ML models) associated with the analytics ID(s) (or set of analytics IDs) by invoking the Nnwdaf_MLModelProvision_Subscribe service operation (S620).

In an embodiment, when the NWDAF containing AnLF 220 stores events and data used to generate analytics at the ADRF 600, the NWDAF containing AnLF 220 may provide ADRF information (e.g., ADRF ID, storage transaction identifier, notification correlation ID).

When the NWDAF containing AnLF 220 collects the actual events to generate the analytics by using the ADRF 600, the NWDAF containing AnLF 220 may provide the ADRF information (e.g., ADRF ID, storage transaction identifier, notification correlation ID).

The ADRF information may include a pair of the ADRF ID and the storage transaction identifier, or the notification correlation ID, or both.

The NWDAF containing MTLF 210 may provide the NWDAF containing AnLF 220 with the trained ML model(s) (or a set of the trained ML models) associated with the analytics ID(s) (or set of analytics IDs) (S630).

The NWDAF containing MTLF 210 may collect actual events and data related to analytics on the ML model during the ML model target period by triggering the data collection procedure (S640). The NWDAF containing MTLF 210 may discover date source NFs by exploiting a target of ML model reporting and ML Model Filter Information to collect the actual events and data.

When the NWDAF containing AnLF 220 provides the ADRF information, the NWDAF containing MTLF 210 may retrieve the events and data for generating the analytics from the ADRF 600.

Step S640 may be triggered by internal logic of the NWDAF containing MTLF 210 or when the NWDAF including the MTLF 210 receives a notification from the ADRF 600 (e.g., Nadrf_DataManagement_RetrievalNotify including a fetch instruction and the notification correlation ID).

When the NWDAF containing AnLF 220 provides the ADRF information, the NWDAF containing MTLF 210 may retrieve the actual events and data from the ADRF 600.

Step S640 may be triggered by internal logic of the NWDAF containing MTLF 210 or when the NWDAF containing MTLF 210 receives a notification from the ADRF 600.

The NWDAF containing MTLF 210 may measure the differences between the set of trained data at step S610 and collected events/data at step S640 (S650).

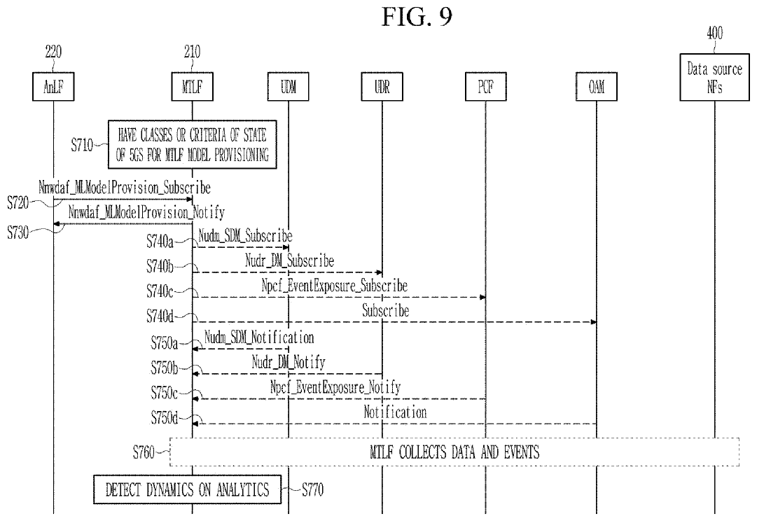

FIG. 9 is a flowchart illustrating a method for detecting dynamics on analytics by MTLF according to an embodiment.

Referring to FIG. 9, the NWDAF containing MTLF 210 may have criteria or classes of state of cellular system (e.g., 5GS) for ML model provision (S710). The state of the cellular system may include, for example, a set of configurations related to a target of analytics reporting, a set of applied policies related to the target of analytics reporting, and a set of expected events related to the target of analytics reporting. The NWDAF containing MTLF 210 may apply the criteria or classes to the selection of ML models for predetermined analytics.

In an embodiment, the classes of the state of the cellular system may be set by the operator's configuration or determined by internal logic of the NWDAF containing MTLF 210.

The NWDAF containing AnLF 220 may subscribe to the trained ML model(s) (set of the trained ML models) associated with the analytics ID(s) (or set of analytics IDs) by invoking the Nnwdaf_MLModelProvision_Subscribe service operation (S720).

The NWDAF containing MTLF 210 may provide a trained ML model(s) (a set of trained ML models) related to the analytics ID(s) (or set of analytics IDs) to the NWDAF containing AnLF 220 according to the criteria and/or classes of the state of the cellular system by invoking Nnwdaf_MLModelProvision_Notify service operation (S730).

The NWDAF containing MTLF 210 may subscribe to at least one service which provides a notification of changes on the state of the cellular system set by the classes (or criteria) for a predetermined target for analytics. (S740a, S740b, S740c, S740d). In an embodiment, the changes on the state of the cellular system set by the classes or criteria may include at least one of occurrence of changes on UE subscription data, occurrence of changes on UE policy, occurrence of changes on AM policy, occurrence of changes on SM related policy, and configuration updates by OAM. The predetermined target for the analytics may include, for example, at least one combination of S-NSSAI(s), UE IDs (e.g., SUPI), UE group ID(s), application ID(s), PDU session ID(s), serving AMF ID(s), and serving SMF (ID)(s).

According to the subscription of the at least one service, the NWDAF containing MTLF 210 may receive information about the occurrence of changes on the state of the cellular system set by the classes (S750a, S750b, S750c, S750d).

In order to evaluate the impact of changes on the state of the cellular system on the performance of the provisioned ML model, the NWDAF containing MTLF 210 may collect the events and data related to the ML model and analytics during the target period of the ML model by triggering the data collection procedure (S760).

The NWDAF containing MTLF 210 may evaluate inconsistency of the provisioned ML model for the changed state of the cellular system received at step S750 with compared to collected events and data (collected in step S760) related to the ML model and analytics and/or the classes (set in step S710) of the state of the cellular system. According to the results of the evaluation, the NWDAF occurrence MTLF 210 may update the classes of the states of the cellular system for ML model provision.

In an embodiment, the NWDAF containing AnLF 220 may measure the error between provided analytics and actual data/events.

In addition, the NWDAF containing MTLF 210 may measure the differences between the trained data set for the provisioned ML model and the actual data/events. In addition, the MTLF 210 may need to consider the errors on analytics, the differences between the actual data/events and the training data sets, and/or the impact of the configuration updates, policy changes, and various unexpected events to improve ML model provisioning services.

In addition, to track the occurrence of changes on the 5GS state, the PCF may support a new event ID(s) (including at least one of UE policy update, AM policy update, and SM policy update) for event exposure.

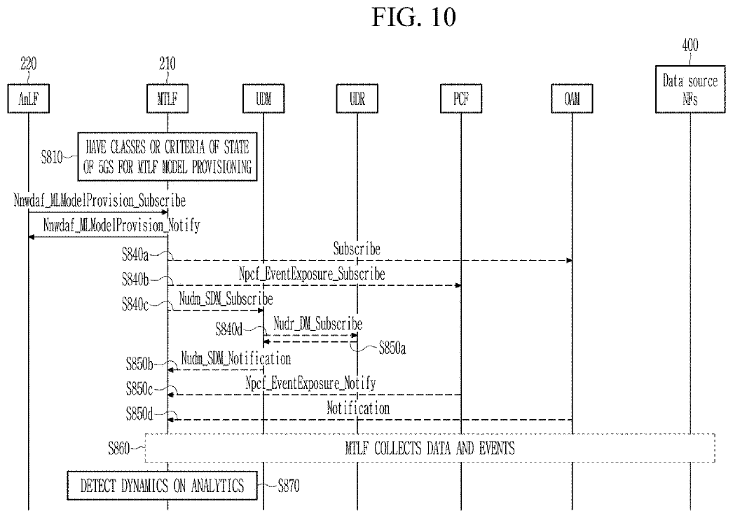

FIG. 10 is a flowchart illustrating a method for detecting dynamics on analytics by MTLF according to another embodiment.

Referring to FIG. 10, the NWDAF containing MTLF 210 may have criteria or classes of state of cellular system (e.g., 5GS) for ML model provisioning (S810). The state of the cellular system may include, for example, a set of configurations related to a target of the analytics reporting, a set of applied policies related to the target of the analytics reporting, and a set of expected events related to the target of the analytics reporting. The NWDAF containing MTLF 210 may apply the criteria or classes to the selection of ML models for predetermined analytics.

In an embodiment, the classes of state of the cellular system may be set by the operator's configuration or determined by internal logic of the NWDAF containing MTLF 210.

The NWDAF containing AnLF 220 may subscribe to a trained ML model(s) (set of trained ML models) associated with the analytics ID(s) (or set of analytics IDs) by invoking the Nnwdaf_MLModelProvision_Subscribe service operation (S820).

The NWDAF containing MTLF 210 may provide the trained ML model(s) (a set of trained ML models) associated with the analytics ID(s) (or set of analytics IDs) to the NWDAF containing AnLF 220 according to the criteria and/or classes of the state of the cellular system by invoking the Nnwdaf_MLModelProvision_Notify service operation (S830).

The NWDAF containing MTLF 210 may subscribe to at least one service which provides a notification of changes on the state of the cellular system set by the classes (or criteria) for a predetermined target for analytics. (S840a, S840b, S840c, S840d).

The MTLF 210 may subscribe to Nudm_SDM_Subscribe service operation provided by the UDM and the UDM may subscribe to the changes of state of the cellular system occurring in the UDR through Nudr_SDM_Subscribe service operation.

In an embodiment, the changes on the state of the cellular system set by the classes or criteria may include at least one of occurrence of changes on UE subscription data, occurrence of changes on UE policy, occurrence of changes on AM policy, occurrence of changes on SM-related policy, and configuration updates by OAM. The predetermined target for the analytics may include, for example, at least one combination of S-NSSAI(s), UE ID (e.g., SUPI), UE group ID(s), application ID(s), PDU session ID(s), serving AMF ID(s), serving SMF (ID)(s).

In an embodiment, the NWDAF containing MTLF 210 may subscribe to the Npcf_EventExposure_Subscribe service operation with the new event ID(s). The new event ID may include at least one of UE policy update, AM policy update, and SM policy update.

When the PCF invokes Npcf_UE/AM/SMPolicyControl_Update_response or Npcf_UE/AM/SMPolicyControl_UpdateNotify service operation, the new event ID(s) of the PCF may notify the occurrence of UE, AM, and SM policy changes to the NWDAF containing MTLF 210, respectively.

In addition, the NWDAF containing MTLF 210 may further subscribe to Nudm_SDM_Subscribe service operation in order to track the occurrence of changes in UE subscription data.

The UE subscription data may include at least one of access and mobility subscription data, session management subscription data, and slice selection subscription data. The UDM may subscribe to notifications from the UDR to track the occurrence of changes on UE subscription data by Nudr_DM_Subscribe.

According to the subscription of the at least one service, the NWDAF containing MTLF 210 may receive information about the occurrence of changes on the state of the cellular system preset by the classes (S850a, S850b, S850c).

In order to evaluate the impact of changes in the state of the cellular system on the performance of the provisioned ML model, the NWDAF containing MTLF 210 may collect the events and data related to the ML model and the analytics during ML model target period by triggering the data collection procedure (S860).

The NWDAF containing MTLF 210 may evaluate inconsistency of the provisioned ML model for the changed state (set in S810) of the cellular system received in step S850 with compared to the classes of state of the cellular system and/or the actual data and events (collected in step S860) (S870). According to the results of the evaluation, the NWDAF containing MTLF 210 may update the classes of state of the cellular system for ML model provision.

In an embodiment, the NWDAF containing AnLF 220 may measure errors between the provided analytics and the actual data/events. The AnLF 220 may store events and data related to the provided analytics in the ADRF during the analytics target period and send the ADRF information to the MTLF. The AnLF 220 may store events and data used for generating analytics in the ADRF and send the ADRF information to the MTLF.

In addition, the NWDAF containing MTLF 210 may measure the differences between the trained data set for the provisioned ML model and the actual data/events. In addition, the MTLF 210 need to consider the errors on analytics, the differences between the actual data/events and the training data sets, and/or the impact of the configuration updates, policy changes, and various unexpected events to improve ML model provision services.

In addition, to track the occurrence of changes on the 5GS state, the PCF may support a new event ID(s) (including at least one of UE policy update, AM policy update, and SM policy update) for event exposure.

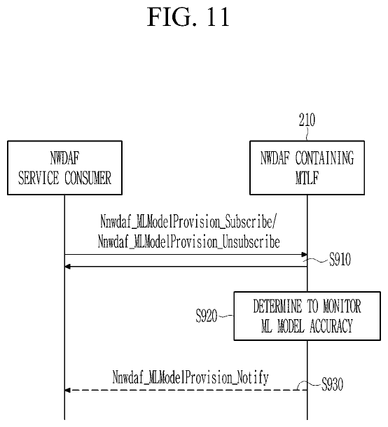

FIG. 11 is a flowchart illustrating a subscription/unsubscription method of the ML model for analytics according to an embodiment.

In an embodiment, a procedure used for an NWDAF service consumer, for example, the NWDAF containing AnLF 220 to subscribe/unsubscribe to another NWDAF (e.g., the NWDAF containing MTLF 210) may be described. The NWDAF service consumer may use the Nnwdaf_MLModelProvision service operation to be notified when ML model information on the related analytics becomes available.

The ML model information may be used to derive analytics by the NWDAF containing AnLF 220. The service may also be used to modify existing ML model subscriptions by the NWDAF. An NWDAF may be a consumer of the service provided by other NWDAF and simultaneously be a provider of the same service for other NWDAF.

Referring to FIG. 11, a consumer of the NWDAF service (e.g., the NWDAF containing AnLF 220) may subscribe to, or modify, or cancel subscription to the service for the trained ML model(s) (or a set of trained ML models) associated with the analytics ID(s) (or set of analytics IDs) by invoking Nnwdaf_MLModelProvision_Subscribe/Nnwdaf_MLModelProvision_Unsubscribe service operations (S910). The parameters that can be provided by the NWDAF service consumer are listed below.

When a subscription for a trained ML model associated with an analytics ID is received, the NWDAF containing MTLF 210 may:
NWDAF containing MTLF 210 may determine whether an existing trained ML model can be used for the subscription; or
may determine whether triggering further training for an existing trained ML model is needed for the subscription.

When the NWDAF containing MTLF 210 determines that further training is needed, the NWDAF may initiate data collection from NFs (e.g., AMF/DCCF/ADRF), UE applications (via AF), or OAM to generate the ML model.

When the service invocation is for subscription modification or subscription cancellation, the NWDAF service consumer may include an identifier (subscription correlation ID) to be modified in the invocation of Nnwdaf_MLModelProvision_Subscribe. When the NWDAF service consumer includes the target of feedback and corresponding feedback information in the invocation of Nnwdaf_MLModelProvision_Subscribe, the NWDAF containing MTLF 210 may use the feedback information to trigger reselection or retraining of the provisioned ML model.

Referring to FIG. 11, the NWDAF containing MTLF 210 may determine to monitor accuracy of the ML model selected in step S910 (S920).

When the NWDAF service consumer subscribes to the trained ML model(s) associated with the analytics ID(s), the NWDAF containing MTLF 210 may notify the NWDAF service consumer with the trained ML model information (including a file address (or a set of the file addresses) of the trained ML model) by invoking Nnwdaf_MLModelProvision_Notify service operation (S930). The contents of the trained ML model information that can be provided by the NWDAF containing MTLF 210 may be described below.

The NWDAF containing MTLF 210 may also invoke the Nnwdaf_MLModelProvision_Notify service operation to notify an available retrained ML model when the NWDAF containing MTLF 210 determines that the previously provided trained ML model required re-training in S910.

When S910 is for subscription modification (i.e., including the subscription correlation ID), the NWDAF containing MTLF 210 may provide either a new trained ML model different from the previously provided model or retrained ML model by invoking the Nnwdaf_MLModelProvision_Notify service operation.

The contents of ML model provisioning, such as parameters that may be provided by NWDAF service consumers and contents of trained ML model information that may be provided by NWDAF, are as follows.

The consumers of the ML model provisioning services (i.e., an NWDAF containing AnLF 220) may provide the input parameters as listed below.

The information of the analytics for which the requested ML model is to be used may include the following.
A list of analytics IDs: identifies the analytics for which the ML model is used.
ML Model Filter Information: enables to select which ML model for the analytics is requested, e.g., S-NSSAI, area of interest. The parameter type in the ML Model Filter Information may be the same as the parameter types of the Analytics Filter Information defined in the procedure.
Target of ML Model Reporting: indicates an object for which ML model is requested, e.g., a specific UE, a group of UEs, or any UE (i.e., all UEs).
ML model Reporting information with the following parameters:

(Only for Nnwdaf_MLModelProvision_Subscribe) ML Model Reporting Information Parameters as Per Event Reporting Information Parameter
ML Model Target Period: indicates time interval [start, end] for which ML model for analytics is requested. The time interval may be expressed with an actual start time and an actual end time (e.g., via UTC time).

Information to enhance the requested ML model accuracy may include the following.
Multiple ML Models Indicator: indicates to provide multiple ML models for an analytics ID to service consumers.
ML Model Accuracy Level: indicates a required level of accuracy (e.g., Accuracy in Training, Mean Absolute Error, etc.) for the ML model, and enables to provide notification when the provisioned ML model accuracy is degraded under the level.
Feedback Indicator: indicates capability of the service consumer (e.g., an NWDAF containing AnLF 220) to support accuracy feedback for the provisioned ML model.
Target of Feedback: indicates the provisioned ML model ID which feedback information is measured.
Feedback Information: includes measured accuracy level (e.g., accuracy in use, mean absolute error, etc.) of the provisioned ML model by service consumer and information (e.g., ADRF ID, storage transaction identifier, DataSetTag) to get data used to generate inference. This information may be included only when the service invocation is for subscription modification or cancellation and the feedback request is enabled in the notification message from the NWDAF containing MTLF 210.
A Notification Target Address (+Notification Correlation ID) may allow to correlate notifications received from the NWDAF containing MTLF 210 with this subscription.

In an embodiment, the input parameters may be extended according to a standardization schedule.

The NWDAF containing MTLF 210 may provide the following output information to consumers of the ML model provisioning service operation.
(Only for Nnwdaf_MLModelProvision_Notify) The notification correlation information
ML model ID(s): identifies the provisioned ML model.

In an embodiment, the ML model ID may be uniquely assigned within a PLMN, and the structure and format of the ML model ID may be up to stage 3.
ML model information including ML model file address(es) (e.g., URL or FQDN) for analytics ID(s).
Validity Period: indicates time period when the provided ML model information applies.
Spatial validity: indicates an area where the provided ML model information applies.

In an embodiment, the spatial validity and validity period may be determined by the MTLF 210 internal logic and may be a subset of AoI when provided in ML model filter information and ML model target period, respectively.
Feedback Request: indicates the NWDAF containing MTLF 210 subscribes accuracy feedback for the provisioned ML model for the service consumer when the feedback indicator is provided in the input parameter.
Data request: indicates the NWDAF containing MTLF 210 to get the input data, ground truth data, and corresponding inference for the ML model provisioned from the service consumer, when the feedback indicator is provided in the input parameter.

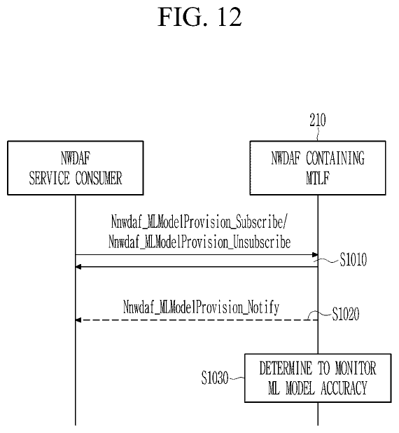

FIG. 12 is a flowchart illustrating the subscription/unsubscription method of the ML model for analytics according to another embodiment.

In another embodiment, a procedure used for an NWDAF service consumer, for example, the NWDAF containing AnLF 220 to subscribe/unsubscribe to another NWDAF (e.g., the NWDAF containing MTLF 210) may be described. The NWDAF service consumer may use the Nnwdaf_MLModelProvision service operation to be notified when ML model information on the related analytics become available.

The ML model information may be used to derive analytics by the NWDAF containing AnLF 220. The service may also be used to modify existing ML model subscriptions by the NWDAF. An NWDAF may be a consumer of the services provided by other NWDAF, and be a provider of the same service for other NWDAF at the same time.

Referring to FIG. 12, the NWDAF service consumer (e.g., the NWDAF containing AnLF 220) may subscribe to, or modify, or cancel subscription to the service for the trained ML model(s) (or a set of trained ML models) associated with the analytics ID(s) (or set of analytics IDs) by invoking the Nnwdaf_MLModelProvision_Subscribe/Nnwdaf_MLModelProvision_Unsubscribe service operation (S1010). The parameters that can be provided by the NWDAF service consumers are listed below. The service consumer may optionally indicate support of the service consumer for multiple ML models, if available.

When a subscription for a trained ML model associated with an analytics ID is received, the NWDAF containing MTLF 210 may:
NWDAF containing MTLF 210 may determine whether an existing trained ML model(s) can be used for the subscription; or
may determine whether triggering further training for an existing trained ML model is required for the subscription.

When the NWDAF containing MTLF 210 determines that further training is required, the NWDAF may initiate data collection from NF (e.g., AMF/DCCF/ADRF), UE applications (via AF), or OAM to generate the ML model.

When the service invocation is for subscription modification or subscription cancellation, the NWDAF service consumer may include an identifier (subscription correlation ID) to be modified in the invocation of Nnwdaf_MLModelProvision_Subscribe.

When the NWDAF service consumer subscribes to the trained ML model(s) associated with the analytics ID(s), the NWDAF containing MTLF 210 may, by invoking Nnwdaf_MLModelProvision_Notify service operation to the NWDAF service consumer,
notify the trained ML model information (including the file address(es) (or set of file addresses) of the trained ML model) when the multiple ML models are not supported by the consumer; or
notify a set of pairs of unique ML Model Identifier and ML model information (ML Model Identifier) related to the analytics ID when the multiple ML models are supported by the consumer (S1020).

In other embodiment, structure and format of the ML model identifier and its uniqueness are up to stage 3.

In another embodiment, parameters defined for the multiple models may be for improving the accuracy of the analytics.

The contents of the trained ML model information that can be provided by the NWDAF containing MTLF 210 are described below.

The NWDAF including the MTLF 210 may also invoke the Nnwdaf_MLModelProvision_Notify service operation to notify either an available re-trained ML model when the NWDAF including the MTLF 210 determines that the previously provided trained ML model is required re-training at step S910, or the ML model is degraded when the ML model accuracy level is provided at step S1010.

When step S1010 is for subscription modification (i.e., including the subscription correlation ID), the NWDAF containing MTLF 210 may provide either a new trained ML model different from the previously provided model or a re-trained ML model by invoking the Nnwdaf_MLModelProvision_Notify service operation.

The NWDAF containing MTLF 210 may determine to monitor the accuracy of the ML model(s) selected in step S1020 (S1030).

The contents of ML model provisioning, such as parameters that may be provided by the NWDAF service consumers and contents of the trained ML model information that may be provided by the NWDAF are as follows.

The consumers of the ML model provisioning service (i.e., NWDAF containing AnLF 220) may provide the input parameters as listed below.

The information of the analytics for which the requested ML model is to be used may include the following.
A list of analytics ID: identifies the analytics for which the ML model is used.
Use case context: indicates the context of use of the analytics to select the most relevant ML model.

In another embodiment, the NWDAF containing MTLF 210 may use the parameter “Use case context” to select the most relevant ML model when several ML models are available for the requested Analytics ID(s).

The values of the use case context parameter may not be standardized.
ML Model Interoperability Information: This is vendor-specific information that conveys, e.g., requested model file format, model execution environment, etc. The encoding, format, and value of the ML Model interoperability Information are not specified because this parameter is vendor specific information, and may be agreed between vendors, if necessary for sharing purposes.
ML Model Filter Information: enables to select which ML model for the analytics is requested (e.g., S-NSSAI, Area of Interest). The parameter type in the ML Model Filter Information may be the same as the parameter type in the Analytics Filter Information defined in the procedures.
Target of ML Model Reporting: indicates the object(s) for which ML model is requested, e.g., specific UEs, a group of UE(s) or any UE (i.e. all UEs).
ML model reporting information with the following parameters:

(Only for Nnwdaf_MLModelProvision_Subscribe) ML Model Reporting Information Parameters as Per Event Reporting Information Parameter
ML Model Target Period: indicates time interval [start, end] for which ML model for the Analytics is requested. The time interval may be expressed as actual start time and actual end time (e.g. via UTC time).
A Notification Target Address (+Notification Correlation ID): allows to correlate notifications received from the NWDAF containing MTLF 210 with this subscription.
Indication of supporting multiple ML models
Accuracy level of Interest

In another embodiment, additional parameters may be required for multi-model provisioning.
Information to enhance the requested ML model accuracy may include the following.
ML Model Accuracy Level: indicates a required level (e.g., Accuracy in Training, Mean Absolute Error, etc.) of accuracy for ML model and enables to provide a notification when the provisioned ML model accuracy is degraded under the level.
Accuracy Provision Capability Indicator: indicates capability of the service consumer (i.e., an NWDAF containing AnLF 220) to support accuracy feedback (i.e., Nnwdaf_AccuracyProvision service) for the provisioned ML model.

The NWDAF containing MTLF 210 may provide the following output information to the consumers of the ML model provisioning service operation.
(Only for Nnwdaf_MLModelProvision_Notify) The Notification Correlation Information
ML model information, which includes:
the ML model file address (e.g. URL or FQDN) for the Analytics ID(s) when the multiple ML models is not supported; or.
a set of pair of unique ML Model identifier and the ML model file address (e.g. URL or FQDN) for the Analytics ID(s) when the multiple ML models is supported.
Validity Period: indicates time period when the provided ML Model Information applies.
Spatial validity: indicates Area where the provided ML Model Information applies.

In another embodiment, spatial validity and validity period may be determined by MTLF 210 internal logic and may be a subset of AoIs when provided in ML model filter information and of ML model target period, respectively.
ML Model Degradation: indicates the provisioned ML model is degraded.

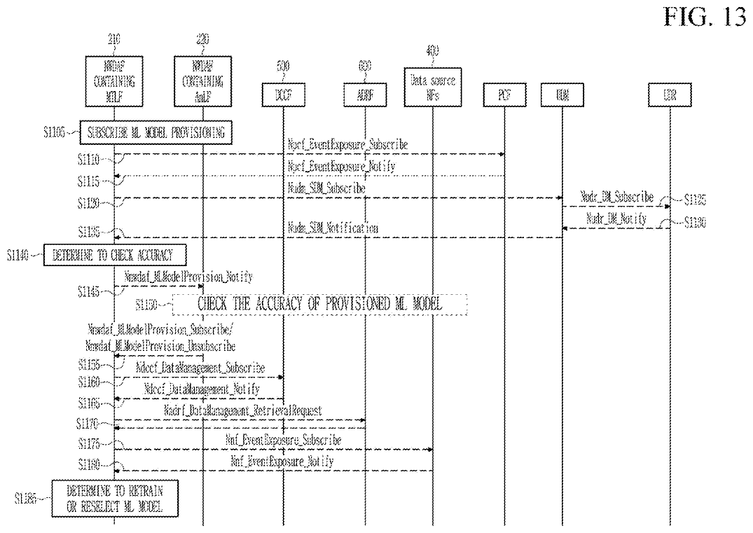

FIG. 13 is a flowchart illustrating a method for monitoring accuracy of an ML model according to an embodiment.

In an embodiment, a method that may be used by NWDAF containing MTLF 210 to determine ML model degradation is described. When the NWDAF containing MTLF 210 determines the ML model degradation for the provisioned ML model, the NWDAF containing MTLF 210 may re-provide an ML model which is retrained or reselected.

Referring to FIG. 13, the NWDAF containing MTLF 210 may provide an ML model to the NWDAF containing AnLF 220 (S1105).

The NWDAF containing MTLF 210 may subscribe to the PCF events for checking changes in the policies for the UE (S1110). In an embodiment, the UE which is a target of policy change may be indicated in a target of ML model reporting in Nnwdaf_MLModelProvision_Subscribe service operation invoked by the NWDAF containing AnLF 220 in step S1105.

When the PCF invokes a service operation related to the policy control update, the PCF may notify to the NWDAF containing MTLF 210 that the occurrence of change in the policy (S1115). The service operation related to the update of the policy control invoked by the PCF may include at least one of Npcf_UEPolicyControl_Update_response, Npcf_AMPolicyControl_Update_response, Npcf_SMPolicyControl_Update_response, Npcf_UEPolicyControl_UpdateNotify, Npcf_AMPolicyControl_UpdateNotify, or Npcf_SMPolicyControl_UpdateNotify service operation.

The NWDAF containing MTLF 210 may subscribe to the UDM to receive notification on UE subscription data change by invoking Nudm_SDM_Subscribe service operation (S1120). In an embodiment, the UE subscription data may include at least one of access and mobility subscription data, session management subscription data, and slice selection subscription data.

When S1120 is triggered, the UDM may subscribe to the UDR to receive notifications of the modification on UE subscription data by invoking Nudr_DM_Subscribe (S1125).

When S1125 is triggered, the UDR may send notification of data change from the UDR regarding on the UE subscription data as indicated in step S1120 by invoking Nudr_DM_Notify (S1130).

When S1120 is triggered, the UDM may notify the change in UE subscription data indicated in step S1120 by invoking Nudm_SDM_Notification (S1135).

The NWDAF containing MTLF 210 may determine to check the provisioned ML model accuracy based on internal logic or configuration, and/or provisioning ML model accuracy level (S1140).

In an embodiment, the configuration used to check the accuracy of the provisioned ML model may utilize notifications in S1115 and S1135. The provisioning ML model accuracy level may be provided in the NWDAF_MLModelProvision_Subscribe service operation by the NWDAF containing AnLF 220 in step S1105.

When the NWDAF containing MTLF 210 determines to check the provisioned ML model accuracy, the NWDAF containing MTLF 210 may perform the following.
the NWDAF containing MTLF 210 may request the NWDAF containing AnLF 220 to check the accuracy of the provisioned ML model when the Feedback Indicator is provided in the Nnwdaf_MLModelProvision_Subscribe service operation (step S1105); and/or
the NWDAF containing MTLF 210 may trigger to collect data from the NWDAF containing AnLF 220, ADRF 600, or other NF to monitor or to build a new test data (including input data, ground truth data and corresponding inference).

When the NWDAF containing AnLF 220 supports accuracy feedback, the NWDAF containing MTLF 210 may request the NWDAF containing AnLF 220 to check the accuracy of the provisioned ML model by invoking the Nnwdaf_MLModelProvision_Notify service operation. Alternatively, the NWDAF containing MTLF 210 may trigger to collect test data from the NWDAF containing AnLF 220 by inputting a Data Request parameter and invoking the Nnwdaf_MLModelProvision_Notify service operation (S1145).

The NWDAF containing AnLF 220 may determine the accuracy of the provisioned ML model based on below (S1150).
Comparing predictions and its corresponding ground truth data.
Comparing changes in internal configuration for the analytics ID generation (e.g. data collection parameters).
Previous existent records of analytics accuracy information.

The NWDAF containing AnLF 220 may send Feedback Information and target of feedback to the NWDAF containing MTLF 210 by invoking the Nnwdaf_MLModelProvision_Subscribe service operation including the subscription correlation ID in step S1105 (S1155).

The NWDAF containing MTLF 210 may subscribe to collect data to monitor the accuracy of the provisioned ML model by invoking the Ndccf_DataManagement_Subscribe service operation S1160.

The DCCF 500 may provide requested data to the NWDAF containing MTLF 210 by invoking Ndccf_DataManagement_Notify service operation (S1165).

When the information for get the data used to generate inference is provided at S1155, the NWDAF containing MTLF 210 may retrieve the data from indicated ADRF with DataSetTag by invoking Nadrf_DataManagement_RetrievalRequest service operation including a Storage Transaction Identifier (S1170).

The NWDAF containing MTLF 210 may subscribe to collect data for monitoring the accuracy of the provisioned ML model by invoking the Nnf_EventExposure_Subscribe service operation (S1175).

The NF may provide requested data to the NWDAF containing MTLF 210 by invoking Nnf_EventExposure_Notify service operation (S1180).

The NWDAF containing MTLF 210 may determine to re-train the provisioned ML model and/or re-select the ML model for the requested analytics by S1105 (S1185).

The service operations used in an embodiment is described below.

service description: This service enables the consumer to receive a notification when an ML model matching the subscription parameters becomes available.

When the subscription is accepted by the NWDAF containing MTLF 210, the consumer NF, i.e. the NWDAF containing AnLF 220, may receive an identifier (subscription correlation ID) from the NWDAF to further manage (modify, delete) this subscription. The modification of the ML model subscription may be enforced by the NWDAF either based on operator policy and configuration, or, if requested by NWDAF containing MTLF 210, to send accuracy information of the provisioned ML model.

Nnwdaf_MLModelProvision_Subscribe Service Operation

service operation name: Nnwdaf_MLModelProvision_Subscribe.

Description: Subscribes to NWDAF ML model provision with specific parameters.

Inputs, required: analytics ID(s) (or set of analytics IDs), notification target address (+notification correlation ID)

Inputs, Optional: Subscription Correlation ID (in the case of modification of the ML model subscription), ML Model Filter Information to indicate the conditions for which ML model for the analytics is requested and Target of ML Model Reporting to indicate the object(s) for which ML model is requested (e.g., specific UEs, or a group of UE(s), or any UE (i.e., all UEs)), ML Model Reporting Information (including e.g., ML Model Target Period), Multiple ML Models Indicator, ML Model Accuracy Level, Feedback Indicator, Target of Feedback, Feedback Information, Expiry time.

Outputs, required (When the subscription is accepted): Subscription Correlation ID (required for management of this subscription), Expiry time (required if the subscription can be expired based on the operator's policy).

Outputs, Optional: None.

Nnwdaf_MLModelProvision_Unsubscribe Service Operation

service operation name: Nnwdaf_MLModelProvision_Unsubscribe.

Description: Unsubscribe to NWDAF ML model provision.

Inputs, required: subscription correlation ID.

Inputs, optional: target of feedback, feedback information.

Outputs, required: Operation execution result indication.

Outputs, optional: None.

Nnwdaf_MLModelProvision_Notify Service Operation

service operation name: Nnwdaf_MLModelProvision_Notify.

Description: NWDAF may notify ML model information to consumer instances subscribing to a specific NWDAF service.

Inputs, required: set of tuples (analytics ID, address of model file (e.g., URL or FQDN)), notification correlation information, ML model ID(s).

Inputs, optional: validity period, spatial validity, feedback request, data request.

Outputs, required: action execution result indication.

Outputs, optional: None.

Nadrf_DataManagement_RetrievalRequest Service Operation

service operation name: Nadrf_DataManagement_RetrievalRequest

Description: The consumer NF uses this service operation to retrieve stored data or analytics from the ADRF. The Nadrf_DataManagement_RetrievalRequest response may either include the data or analytics, or provide instructions for fetching the data or analytics. The Nadrf_DataManagement_RetrievalRequest service operation may be unsolicited (e.g., when the consumer itself has known “Storage Transaction Identifier”) or sent in response to a fetch instructions received from the ADRF in an Nadrf_DataManagement_RetrievalNotify service operation.

Inputs, required: One of the followings:
storage transaction identifier; or
Fetch Correlation ID(s) when the RetrievalRequest is in response to a fetch instruction received from the ADRF in the operation of the Nadrf_DataManagement_RetrievalNotify.

Inputs, optional: DataSetTag.

Outputs, required: Result indication.

Outputs, optional: data or analytics.

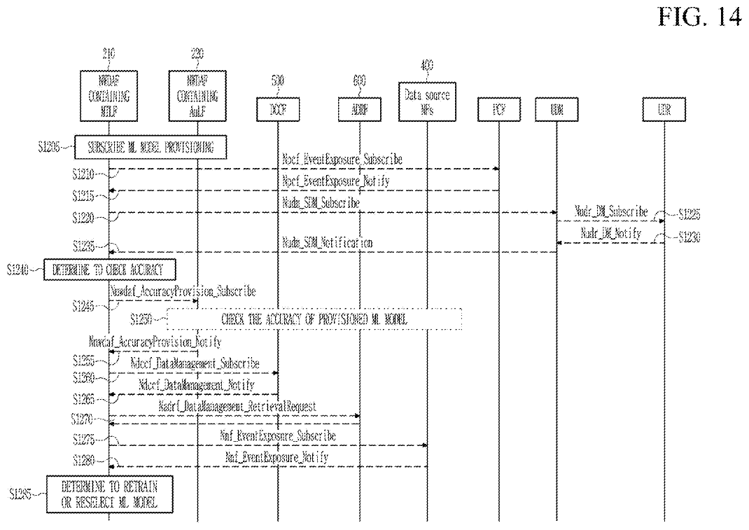

FIG. 14 is a flowchart illustrating a method for monitoring the accuracy of the ML model according to another embodiment.

In another embodiment, a method that may be used by the NWDAF containing MTLF 210 to determine ML model degradation is described. When the NWDAF containing MTLF 210 determines the ML model degradation for the provisioned ML model, the NWDAF containing MTLF 210 may re-provide an ML model which is retrained or reselected.

Referring to FIG. 14, the NWDAF containing MTLF 210 may provide an ML model to the NWDAF containing AnLF 220 (S1205).

The NWDAF containing MTLF 210 may subscribe to the PCF event for checking changes in the policies for the UE (S1210). In an embodiment, the UE, which is a change target of the policy, may be indicated in a target of ML model reporting in Nnwdaf_MLModelProvision_Subscribe service operation invoked by the NWDAF containing AnLF 220 at S1205.

When the PCF invokes a service operation related to policy control update, the PCF may notify the NWDAF containing MTLF 210 of the occurrence of changes in the policy (S1215). The service operation related to the update of the policy control invoked by the PCF may include at least one of Npcf_UEPolicyControl_Update_response, Npcf_AMPolicyControl_Update_response, Npcf_SMPolicyControl_Update_response, Npcf_UEPolicyControl_UpdateNotify, Npcf_AMPolicyControl_UpdateNotify, or Npcf_SMPolicyControl_UpdateNotify service operation.

The NWDAF containing MTLF 210 may subscribe to the UDM to get notifications on UE subscription data change by invoking Nudm_SDM_Subscribe service operation (S1220). In an embodiment, the UE subscription data may include at least one of access and mobility subscription data, session management subscription data, and slice selection subscription data.

When S1220 is triggered, the UDM may subscribe to the UDR to get a notification of the modification on the UE subscription data by invoking Nudr_DM_Subscribe (S1225).

When S1225 is triggered, the UDR may send a notification of data change from the UDR regarding on the UE subscription data as indicated in S1220 by invoking Nudr_DM_Notify (S1230).

When S1220 is triggered, the UDM may notify the change in the UE subscription data indicated in S1220 by invoking Nudm_SDM_Notification (S1235).

The NWDAF containing MTLF 210 may determine to check the provisioned ML model accuracy based on internal logic or configuration, and/or the provisioning ML model accuracy level (S1240). In an embodiment, the notification received in steps S1215 and S1235 may be used for the internal logic and/or configuration used to check the provisioned ML model accuracy. The provisioning ML model accuracy level may be provided in NWDAF_MLModelProvision_Subscribe service operation by the NWDAF containing AnLF 220 in S1205.

When the NWDAF containing MTLF 210 decides to check the provisioned ML model accuracy, the NWDAF containing MTLF 210 may perform the following.
The NWDAF containing MTLF 210 may request the NWDAF containing AnLF 220 to check the accuracy of the provisioned ML model when the Accuracy Provision Capability Indicator is provided in the Nnwdaf_MLModelProvision_Subscribe service operation at S1205; and/or
The NWDAF containing MTLF 210 may trigger to collect data from NWDAF containing AnLF 220, or ADRF 600, or other NFs to monitor or build new test data (including input data, ground truth data, and corresponding inferences)

When the NWDAF containing AnLF 220 supports accuracy feedback (i.e., Nnwdaf_AccuracyProvision service), the NWDAF containing MTLF 210 may request the NWDAF containing AnLF 220 to check the accuracy of the provisioned ML model by invoking Nnwdaf_AccuracyProvision_Subscribe service operation enabling Measured Accuracy Request Indicator with the notification correlation ID for the Nnwdaf_MLModelProvision service. Alternatively, the NWDAF containing MTLF 210 may trigger to collect test data from the NWDAF containing AnLF 220 by invoking the Nnwdaf_AccuracyProvision_Subscribe service operation with enabling Accuracy related Data Request Indicator (S1245).

The NWDAF containing AnLF 220 may determine the accuracy of the provided ML model (S1250).

The NWDAF containing AnLF 220 may send Accuracy Information and ML model identifier to the NWDAF containing MTLF 210 by invoking the Nnwdaf_AccuracyProvision_Notify service operation (S1255).

The NWDAF containing MTLF 210 may subscribe to collect data to monitor the accuracy of the provisioned ML model by invoking the Ndccf_DataManagement_Subscribe service operation (S1260).

The DCCF 500 may provide requested data to the NWDAF containing MTLF 210 by invoking Ndccf_DataManagement_Notify (S1265).

When the information for obtaining data used for generating inference is provided in S1255, the NWDAF containing MTLF 210 may retrieve the data from indicated ADRF with the DataSetTag by invoking Nadrf_DataManagement_RetrievalRequest service operation including the Storage Transaction Identifier (S1270).

The NWDAF containing MTLF 210 may subscribe to collect data for monitoring the accuracy of the provisioned ML model by invoking the Nnf_EventExposure_Subscribe service operation (S1275).

The NF may provide requested data to the NWDAF containing MTLF 210 by invoking Nnf_EventExposure_Notify (S1280).

The NWDAF containing MTLF 210 may determine to re-train the provisioned ML model and/or re-select the ML model for requested analytics by S1105 (S1285).

The accuracy provisioning according to another embodiment is described below.

Contents of Accuracy Provisioning

The consumers of the Accuracy Provisioning service (i.e., NWDAF containing AnLF 220) may provide the input parameters listed below.
Information of the ML model for which the requested accuracy is to be measured may include the following:
A list of ML model identifiers: identifies the ML model for which the accuracy is to be measured.
Measured Accuracy Request Indicator: indicates the service consumer to get measured accuracy of the ML model.
Accuracy related Data Request Indicator: indicates the service consumer to get the input data, ground truth data, and corresponding inference for the ML model.
Notification Correlation ID of ML Model Provisioning service, which allows to correlated notifications received from the subscription of Nnwdaf_MLModelProvision service provided by the service consumer (i.e., NWDAF containing MTLF) with this subscription.
Use case context: indicates the context of use of the ML model.
Target of Accuracy Reporting: indicates the object(s) for which accuracy provisioning is requested, e.g., specific UEs, or a group of UE(s), or any UE (i.e., all UEs).
ML Model Accuracy Level: Indicates a required level of accuracy of the ML model (e.g., accuracy in training, mean absolute value error, etc.), and enables to provide a notification when the ML model accuracy is degraded under the level.
Accuracy reporting information: Parameters as per event reporting information parameter.
A notification target address (+notification correlation ID).

The NWDAF may provide the output information listed below to the consumers of the Nnwdaf_AccuracyProvision_Notify service operation.
The Notification Correlation ID.
For each ML model identifier, the accuracy information:
Measured Accuracy Information: includes measured accuracy level (e.g., accuracy in use, mean absolute error, etc.) of the ML model by service consumers.
Accuracy related data information: may include either the collected data used to measure the accuracy of the ML model, or information to retrieve the collected data such as ADRF ID, storage transaction identifier, or DataSetTag.
ML model degradation: may indicate that the provisioned ML model has degraded.

Table 1 below shows NF services that may be provided by NWDAF.

TABLE 1

| service name | service operations | Operation semantics | Example consumer(s) |
|---|---|---|---|
| Nnwdaf_AnalyticsSubscription | Subscribe | Subscribe/Notify | PCF, NSSF, AMF, SMF, |
| | | | NEF, AF, OAM, CEF, |
| | | | NWDAF, DCCF |
| | Unsubscribe | | PCF, NSSF, AMF, SMF, |
| | | | NEF, AF, OAM, CEF, |
| | | | NWDAF, DCCF |
| | Notify | | PCF, NSSF, AMF, SMF, |
| | | | NEF, AF, OAM, CEF, |
| | | | NWDAF, DCCF, MFAF |
| | Transfer | Request/Response | NWDAF |
| Nnwdaf_AnalyticsInfo | Request | Request/Response | PCF, NSSF, AMF, SMF, |
| | | | NEF, AF, OAM, CEF, |
| | | | NWDAF, DCCF |
| | ContextTransfer | Request/Response | NWDAF |
| Nnwdaf_DataManagement | Subscribe | Subscribe/Notify | NWDAF, DCCF |
| | Notify | | NWDAF, DCCF, MFAF, ADRF |
| | Fetch | Request/Response | NWDAF, DCCF, MFAF, ADRF |
| Nnwdaf_MLModelProvision | Subscribe | Subscribe/Notify | NWDAF |
| | Unsubscribe | | NWDAF |
| | Notify | | NWDAF |
| Nnwdaf_MLModelInfo | Request | Request/Response | NWDAF |
| Nnwdaf_AccuracyProvision | Subscribe | Subscribe/Notify | NWDAF |
| | Unsubscribe | | NWDAF |
| | Notify | | NWDAF |

NOTE 1:
How OAM consumes Nnwdaf services and which Analytics information is relevant is defined in TS 28.550 [7] Annex H and out of the scope of this TS.
NOTE 2:
How CEF consumes Nnwdaf services and which Analytics information is relevant is defined in TS 28.201 [21] and out of the scope of this TS.
NOTE 3:
The Nnwdaf_MLModelProvision service and the Nnwdaf_MLModelInfo service are provided by an NWDAF containing MTLF and consumed by an NWDAF containing AnLF.

Table 2 below shows analytics that may be provided by the NWDAF service.

TABLE 2

| Analytics | | |
|---|---|---|
| information | request description | response description |
| Slice Load level | Analytics ID: load level | Load level provided as number of UE |
| information | information | registrations and number of PDU sessions for |
| | | a Network Slice and Network Slice instances |
| | | as well as resource utilization for Network |
| | | Slice instances. |
| Observed Service | Analytics ID: Service | Observed Service experience statistics or |
| experience | Experience | predictions may be provided for a Network |
| information | | Slice or an Application. They may be derived |
| | | from an individual UE, a group of UEs or any |
| | | UE. For slice service experience, they may be |
| | | derived from an Application, a set of |
| | | Applications or all Applications on the |
| | | Network Slice. |
| NF Load | Analytics ID: NF load | Load statistics or predictions information for |
| information | information | specific NF(s). |
| Network | Analytics ID: Network | Statistics or predictions on the load in an |
| Performance | Performance | Area of Interest; in addition, statistics or |
| information | | predictions on the number of UEs that are |
| | | located in that Area of Interest. |
| UE mobility | Analytics ID: UE Mobility | Statistics or predictions on UE mobility. |
| information | | When visited AOI(s) is included in the |
| | | Analytics Filter information, only statistics |
| | | on UE mobility may be provided. |
| UE Communication | Analytics ID: UE | Statistics or predictions on UE |
| information | Communication | communication. |
| Expected UE | Analytics ID: UE Mobility | Analytics on UE Mobility and/or UE |
| behavioural | and/or UE Communication | Communication. |
| parameters | | |
| UE Abnormal | Analytics ID: Abnormal | List of observed or expected exceptions, with |
| behaviour | behaviour | Exception ID, Exception Level and other |
| information | | information, depending on the observed or |
| | | expected exceptions. |
| User Data | Analytics ID: User Data | Statistics or predictions on the user data |
| Congestion | Congestion | congestion for transfer over the user plane, |
| information | | for transfer over the control plane, or for both. |
| QoS | Analytics ID: QoS | For statistics, the information on the location |
| Sustainability | Sustainability | and the time for the QoS change and the |
| | | threshold(s) that were crossed; or, for |
| | | predictions, the information on the location |
| | | and the time when a potential QoS change |
| | | may occur and what threshold(s) may be crossed. |
| Session | Analytics ID: Session | Statistics on session management congestion |
| Management | Management Congestion | control experience for specific DNN and/or |
| Congestion | Control Experience | S-NSSAI. |
| Control | | |
| Experience | | |
| Redundant | Analytics ID: Redundant | Statistics or predictions aimed at supporting |
| Transmission | Transmission Experience | redundant transmission decisions for URLLC |
| Experience | | services. |
| WLAN | Analytics ID: WLAN | Statistics or predictions on WLAN |
| performance | performance | performance of UE. |
| Dispersion | Analytics ID: UE Dispersion | Statistics or predictions that identify the |
| | | location (i.e., areas of interest) or network |
| | | slice(s) where a UE, or a group of UEs |
| | | disperse their data volume, or disperse |
| | | mobility or session management transactions |
| | | or both. |
| DN Performance | Analytics ID: DN | Statistics or predictions on user plane |
| | Performance | performance for a specific Edge Computing |
| | | application. |

The service operation used in another embodiment is described below.

Nnwdaf_MLModelProvision_Subscribe Service Operation

service operation name: Nnwdaf_MLModelProvision_Subscribe.

Description: Subscribe to NWDAF ML model provision with specific parameters.

Input, required: analytics ID(s) (or set of analytics IDs), notification target address (+notification correlation ID)

Inputs, Optional: Subscription Correlation ID (in the case of modification of the ML model subscription), ML Model Filter Information to indicate the conditions for which ML model for the analytics is requested and Target of ML Model Reporting to indicate the object(s) for which ML model is requested (e.g., specific UEs, or a group of UE(s), or any UE (i.e., all UEs)), ML Model Reporting Information (including e.g., ML Model Target Period), Expiry time, Use case context, indication of support for multiple ML models, multiple ML models Filter Information to indicate the conditions for which multiple ML models are requested, ML Model Accuracy Level, Accuracy Provision Capability Indicator.

Outputs Required (When the subscription is accepted): Subscription Correlation ID (required for management of this subscription), Expiry time (required if the subscription can be expired based on the operator's policy).

Outputs, Optional: None.

Nadrf_DataManagement_RetrievalRequest Service Operation

service operation name: Nadrf_DataManagement_RetrievalRequest

Description: The consumer NF may use this service operation to retrieve stored data or analytics from the ADRF. The Nadrf_DataManagement_RetrievalRequest response may either include the data or analytics, or provide instructions for retrieving the data or analytics. The Nadrf_DataManagement_RetrievalRequest may be unsolicited (e.g., when the consumer itself has known “Storage Transaction Identifier”) or sent in response to a fetch instructions received from the ADRF in an Nadrf_DataManagement_RetrievalNotify.

Inputs, required: One of the followings:
Storage Transaction Identifier; or
Fetch Correlation ID(s), when the RetrievalRequest is in response to the fetch instruction received from the ADRF in an Nadrf_DataManagement_RetrievalNotify.

Inputs, optional: DataSetTag.

Outputs, required: result indication.

Outputs, optional: data or analytics.

As described above, the NWDAF can measure the error between the provided analytics and the actual data/events. The NWDAF may also measure the difference between the trained data set and the actual data/events for a provisioned ML model. Further, the NWDAF may consider errors in the analyzed information, differences between the actual data/events and the trained data set, and/or the impact of configuration updates, policy changes, and various unexpected events, in order to enhance the provisioning service of the ML model. In addition, to track the occurrence of changes in 5GS state, the PCF can support new event IDs for event exposures.

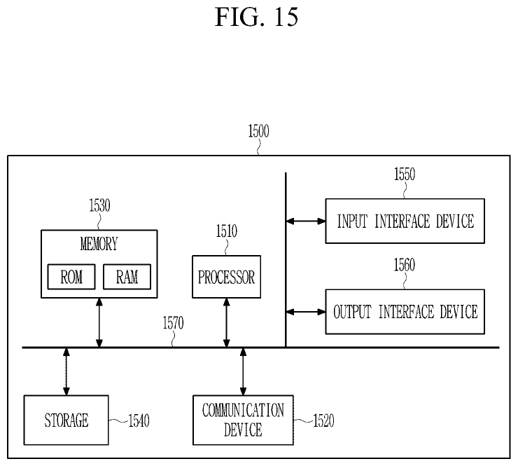

FIG. 15 is a block diagram illustrating a network function according to an embodiment.

The network function according to an embodiment may be implemented as a computer system, for example, a computer-readable medium. Referring to FIG. 15, the computer system 1500 may include at least one of a processor 1510, a memory 1530, an input interface device 1550, an output interface device 1560, and a storage device 1540 communicating through a bus 1570. The computer system 1500 may also include a communication device 1520 coupled to the network. The processor 1510 may be a central processing unit (CPU) or a semiconductor device that executes instructions stored in the memory 1530 or the storage device 1540. The memory 1530 and the storage device 1540 may include various forms of volatile or nonvolatile storage media. For example, the memory may include read only memory (ROM) or random-access memory (RAM). In the embodiment of the present disclosure, the memory may be located inside or outside the processor, and the memory may be coupled to the processor through various means already known. The memory is a volatile or nonvolatile storage medium of various types, for example, the memory may include read-only memory (ROM) or random-access memory (RAM).

Accordingly, the embodiment may be implemented as a method implemented in the computer, or as a non-transitory computer-readable medium in which computer executable instructions are stored. In an embodiment, when executed by a processor, the computer-readable instruction may perform the method according to at least one aspect of the present disclosure.

The communication device 1520 may transmit or receive a wired signal or a wireless signal.

On the contrary, the embodiments are not implemented only by the apparatuses and/or methods described so far, but may be implemented through a program realizing the function corresponding to the configuration of the embodiment of the present disclosure or a recording medium on which the program is recorded. Such an embodiment can be easily implemented by those skilled in the art from the description of the embodiments described above. Specifically, methods (e.g., network management methods, data transmission methods, transmission schedule generation methods, etc.) according to embodiments of the present disclosure may be implemented in the form of program instructions that may be executed through various computer means, and be recorded in the computer-readable medium. The computer-readable medium may include program instructions, data files, data structures, and the like, alone or in combination. The program instructions to be recorded on the computer-readable medium may be those specially designed or constructed for the embodiments of the present disclosure or may be known and available to those of ordinary skill in the computer software arts. The computer-readable recording medium may include a hardware device configured to store and execute program instructions. For example, the computer-readable recording medium can be any type of storage media such as magnetic media like hard disks, floppy disks, and magnetic tapes, optical media like CD-ROMs, DVDs, magneto-optical media like floptical disks, and ROM, RAM, flash memory, and the like. Program instructions may include machine language code such as those produced by a compiler, as well as high-level language code that may be executed by a computer via an interpreter, or the like.

Accordingly, the embodiment may be implemented as a method implemented in the computer, or as a non-transitory computer-readable medium in which computer executable instructions are stored. In an embodiment, when executed by a processor, the computer-readable instruction may perform the method according to at least one aspect of the present disclosure.

The communication device 1520 may transmit or receive a wired signal or a wireless signal.

On the contrary, the embodiments are not implemented only by the apparatuses and/or methods described so far, but may be implemented through a program realizing the function corresponding to the configuration of the embodiment of the present disclosure or a recording medium on which the program is recorded. Such an embodiment can be easily implemented by those skilled in the art from the description of the embodiments described above. Specifically, methods (e.g., network management methods, data transmission methods, transmission schedule generation methods, etc.) according to embodiments of the present disclosure may be implemented in the form of program instructions that may be executed through various computer means, and be recorded in the computer-readable medium. The computer-readable medium may include program instructions, data files, data structures, and the like, alone or in combination. The program instructions to be recorded on the computer-readable medium may be those specially designed or constructed for the embodiments of the present disclosure or may be known and available to those of ordinary skill in the computer software arts. The computer-readable recording medium may include a hardware device configured to store and execute program instructions. For example, the computer-readable recording medium can be any type of storage media such as magnetic media like hard disks, floppy disks, and magnetic tapes, optical media like CD-ROMs, DVDs, magneto-optical media like floptical disks, and ROM, RAM, flash memory, and the like.

Program instructions may include machine language code such as those produced by a compiler, as well as high-level language code that may be executed by a computer via an interpreter, or the like.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software. The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers.

A computer program(s) may be written in any form of a programming language, including compiled or interpreted languages, and may be deployed in any form including a stand-alone program or a module, a component, a subroutine, or other units suitable for use in a computing environment.

A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random-access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks.

Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium.

A processor and a memory may be supplemented by, or integrated into, a special purpose logic circuit. The processor may run an operating system 08 and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements.

For example, a processor device may include multiple processors or a processor and a controller. In addition, different processing configurations are possible, such as parallel processors. Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment.

Features described in the specification in the context of individual example embodiments may be implemented as a combination in a single example embodiment. In contrast, various features described in the specification in the context of a single example embodiment may be implemented in multiple example embodiments individually or in an appropriate sub-combination.

Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

While this disclosure has been described in connection with what is presently considered to be practical example embodiments, it is to be understood that this disclosure is not limited to the disclosed embodiments.

On the contrary, it is intended to cover various modifications and equivalent arrangements included within the spirit and scope of the appended claims.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

What is claimed is:

1. A method for evaluating a machine learning (ML) model, comprising:
receiving a provisioning request for the ML model from a network data analytics function (NWDAF) including an analytics logical function (AnLF) in a cellular system;
collecting data for monitoring accuracy of the ML model; and
evaluating the ML model based on the collected data.

2. The method of claim 1, further comprising:
reselecting or retraining an ML model of which the accuracy is determined to be deteriorated according to the evaluation result of the ML model; and
providing the reselected or retrained ML model to the NWDAF.

3. The method of claim 1, wherein the receiving a provisioning request for the ML model from the NWDAF comprises:
receiving, from the NWDAF, at least one of subscription correlation ID, ML model filter information, a target of ML model reporting, ML model reporting information, indicators of multiple ML model, ML model accuracy level, a feedback indicator, a target of feedback, feedback information, and expiration time.

4. The method of claim 1, further comprising:
determining to check the accuracy of the ML model based on a notification received from a policy control function (PCF) in the cellular system.

5. The method of claim 4, wherein the notification includes a notification about a change in policy for user equipment (UE).

6. The method of claim 1, wherein the collecting data for monitoring accuracy of the ML model comprises:
subscribing to the NWDAF by invoking a service operation for accuracy provisioning; and
receiving accuracy information of the ML model from the NWDAF from the NWDAF.

7. The method of claim 6, wherein receiving accuracy information of the ML model from the NWDAF from the NWDAF further comprises:
receiving a storage transaction identifier from the NWDAF.

8. The method of claim 7, wherein the collecting data for monitoring accuracy of the ML model further comprises:
retrieving data from analytics data repository (ADRF) using the storage transaction identifier.

9. A method for using a machine learning (ML) model, comprising:
requesting provisioning of the ML model to a network data analytics function (NWDAF) including an ML model training logical function (MTLF) in a cellular system;
transmitting accuracy information of the ML model to the NWDAF when a service operation for accuracy provisioning is invoked by the NWDAF; and
receiving a reselected or retrained ML model from the NWDAF after the ML model is evaluated based on the accuracy information by the NWDAF.

10. The method of claim 9, wherein the requesting provisioning of the ML model to the NWDAF comprises:
transmitting, to the NWDAF, at least one of subscription correlation ID, ML model filter information, a target of ML model reporting, ML model reporting information, indicators of multiple ML model, ML model accuracy level, a feedback indicator, a target of feedback, feedback information, and expiration time.

11. The method of claim 9, wherein the transmitting the accuracy information of the ML model to the NWDAF comprises:
sending a storage transaction identifier to the NWDAF.

12. A network data analytics function (NWDAF) including a machine learning (ML) model training logical function (MTLF) in a cellular system, comprising:
a processor, a memory, and a communication device, wherein the processor executes a program stored in the memory to perform:
receiving a provisioning request for an ML model from a first NWDAF including an analytics logical function (AnLF) in the cellular system;
collecting data for monitoring accuracy of the ML model; and
evaluating the ML model based on the collected data.

13. The NWDAF of claim 12, wherein the processor executes the program to further perform:
reselecting or retraining an ML model of which the accuracy is determined to be deteriorated according to the evaluation result of the ML model; and
providing the reselected or retrained ML model to the NWDAF.

14. The NWDAF of claim 12, wherein when performing the receiving the provisioning request for the ML model from the NWDAF, the processor performs:
receiving, from the NWDAF, at least one of subscription correlation ID, ML model filter information, a target of ML model reporting, ML model reporting information, indicators of multiple ML model, ML model accuracy level, a feedback indicator, a target of feedback, feedback information, and expiration time.

15. The NWDAF of claim 12, wherein the processor executes the program to further perform:
determining to check the accuracy of the ML model based on a notification received from a policy control function (PCF) in the cellular system.

16. The NWDAF of claim 15, wherein the notification includes a notification about a change in policy for user equipment (UE).

17. The NWDAF of claim 12, wherein when performing the collecting data for monitoring accuracy of the ML model, the processor performs:
subscribing to the NWDAF by invoking a service operation for accuracy provisioning; and
receiving accuracy information of the ML model from the NWDAF from the NWDAF.

18. The NWDAF of claim 17, wherein when performing the receiving the accuracy information of the ML model from the NWDAF from the NWDAF, the processor performs:
receiving a storage transaction identifier from the NWDAF.

19. The NWDAF of claim 18, wherein when performing the collecting data for monitoring accuracy of the ML model, the processor performs:
retrieving data from analytics data repository (ADRF) using the storage transaction identifier.
